(19) United States
(12) Patent Application Publication
(10) Pub. No.: US 2009/0180656 A1
(43) Pub. Date: Jul. 16, 2009

(54) Microphone holding method and apparatus

(76) Inventor: Ronnie Benditt, Phoenixville, PA (US)

Correspondence Address: Ronnie Benditt, 1953 Revolutionary Court, Phoenixville, PA, 19460, US

(21) Appl. No.: 12/008,969

(22) Filed: Jan. 16, 2008

(51) Int. Cl. H04R 11/04

(52) U.S. Cl. 381/362

(57) ABSTRACT

A method and apparatus for holding a microphone is described where a support member containing either flexible legs or an elastomeric pad is compressed between an amplifier and a speaker cabinet to provide support for a microphone for the purpose of capturing the sound coming out of a speaker. Additionally, the same device may be used to mount a microphone on a combo-style amplifier by compressing the support member under the amplifier's handle.

### BACKGROUND OF THE INVENTION

The present invention pertains generally to musical stage equipment, and more particularly to the mounting of microphone equipment.

Musicians who play onstage typically use a public address system (PA system) to amplify their audio. To accomplish this, all audio streams are routed into a mixer and then amplified to the proper volume level. The amplifier is then connected to a speaker system for the audience to hear.

Onstage, musicians often have amplified instruments such as guitars. The guitar amplifier and speaker combination often play a large factor in the coloration of the sound that is achieved. However, the guitar amplifier is not usually meant to be the primary source of audio that the audience hears for a number of reasons. First, the power of the guitar amplifier may not be enough to support the venue. Secondly, the speaker placement is usually less than ideal for the audience. And thirdly, the onstage nature of the system precludes the soundman from making adjustments as needed.

Some musicians have opted to run an output line from their amplifier directly to the soundman's mixing board, sometimes utilizing a “direct box” to match the impedances. This approach gives the soundman an audio feed that can be mixed and adjusted on the mixing board. The downside to this approach is that the tone of the particular guitar amplifier's speaker cabinet is lost.

To retain the true sound of the guitar amplifier and speaker cabinet, soundmen very often use microphones onstage to capture the sound coming out of the guitarist's speaker cabinet. The most common way to hold a microphone in front of a speaker cabinet is by using floor-mounted microphone stands. These stands are typically tripod devices that sit on the floor and hold a microphone in front of the speaker. Such systems are prone to stage noise transmitted through the floor and provide a delicate arrangement of clutter that can easily be knocked over or moved out of position should a stage performer get too close.

There have been some previous attempts to overcome these shortcomings. Kuerti et al. presents a microphone mount design that clamps onto the edge of the speaker cabinet in U.S. Pat. No. 6,842,528. While this method does eliminate much of the floor clutter associated with floor stands, the clamp is prone to slippage if it is not tightened enough.

Kuerti et al. has presented another design in U.S. Pat. No. 6,498,859 where the microphone stand is held in a holder that is screwed to the side of the speaker cabinet. In this way, the microphone stand can be removed during transport, leaving behind the holder device that is attached to the speaker cabinet. The disadvantage to this method is that many musicians are reluctant to modify their equipment by screwing on a holding device. Also, if the installed position is not correct, additional holes need to be made in expensive audio equipment in order to re-mount the unit. Further, the installation of such a system has the potential for damaging the speaker cabinet and its internal components if the installation is not done with great care.

### BRIEF SUMMARY OF THE INVENTION

The present invention is a holder for supporting a microphone in front of a speaker cabinet. The invention consists of a support member, a vertical pole, and a microphone holder. The support member is a spring-like device that fits into the gap between the amplifier and speaker cabinet in order to support the pole, microphone clip, and attached microphone.

### BRIEF DESCRIPTION OF THE SEVERAL VIEWS OF THE DRAWING

FIG. 1 shows a perspective view of a microphone holder

FIG. 2 shows a perspective view of a microphone holder mounted on a guitar amplifier

FIG. 3 shows a perspective view of a microphone holder mounted on a combo-type amplifier

FIG. 4 shows an alternative embodiment with an elastomeric pad

### DETAILED DESCRIPTION OF THE INVENTION

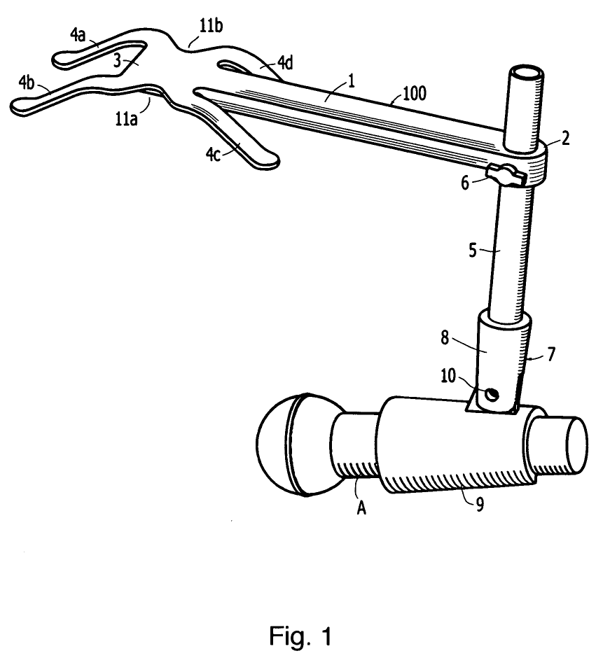

A preferred embodiment of the present invention is illustrated in FIG. 1. A microphone holder assembly 100 consists of a support member 1 comprising a distal end 2 and a proximal end 3. Said proximal end contains one or more flexible members 4. Said proximal end 2 holds a rod 3 that is held in place inside of distal end 2 by means of a thumbscrew 6. A microphone bracket assembly 7 is attached to one end of said rod 5. Said microphone bracket assembly 7 can be any one of the common varieties that is in common use on floor-mounted microphone stands. In this embodiment, said microphone bracket assembly 7 consists of a rod attachment 8 and a microphone clip 9 wherein said microphone clip 9 is attached to said rod attachment 8 by a pivoting joint 10. A microphone A may be held in the microphone bracket assembly 7.

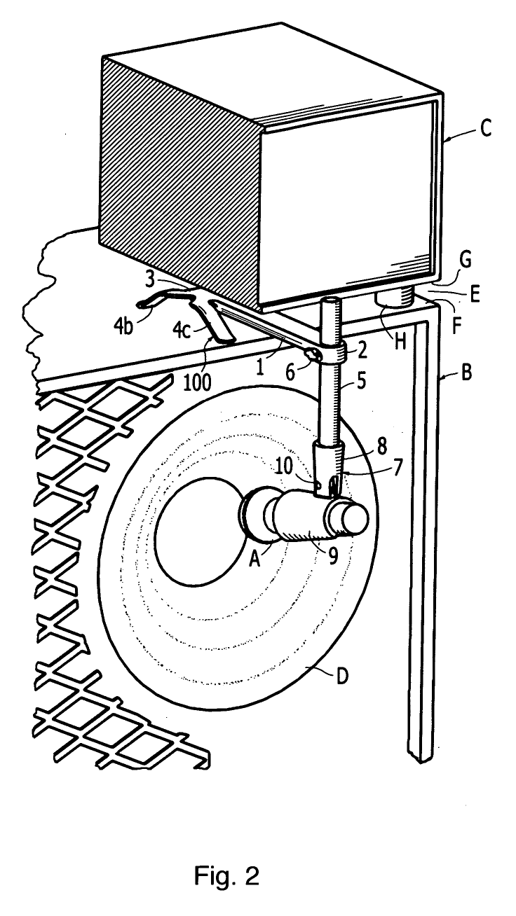

FIG. 2 shows the microphone holder assembly 100 in operation. Support member 1 is placed between the gap E that is formed between an amplifier C, shown in partial cross-section, and speaker cabinet B. Gap E is formed because the amplifier C has feet H on its underside. The height of the support member 1 is bigger than the space provided by gap E, thus flexible members 4 flex to a more flattened position. In the installed position, flexible members 4 act as leaf springs to apply a holding force between lower mounting surface F and upper mounting surface G.

With support member 2 firmly held in gap E as described, microphone A can be positioned in front of speaker D. The vertical position of microphone A can be adjusted by means of thumbscrew 6 to allow rod 5 to slide axially to a new position within distal end 2 of support member 1. Angular adjustment of microphone A can be achieved by adjusting the pivot joint 10 of microphone bracket assembly 7. Other positional adjustment may be achieved by repositioning support member 1 within gap E.

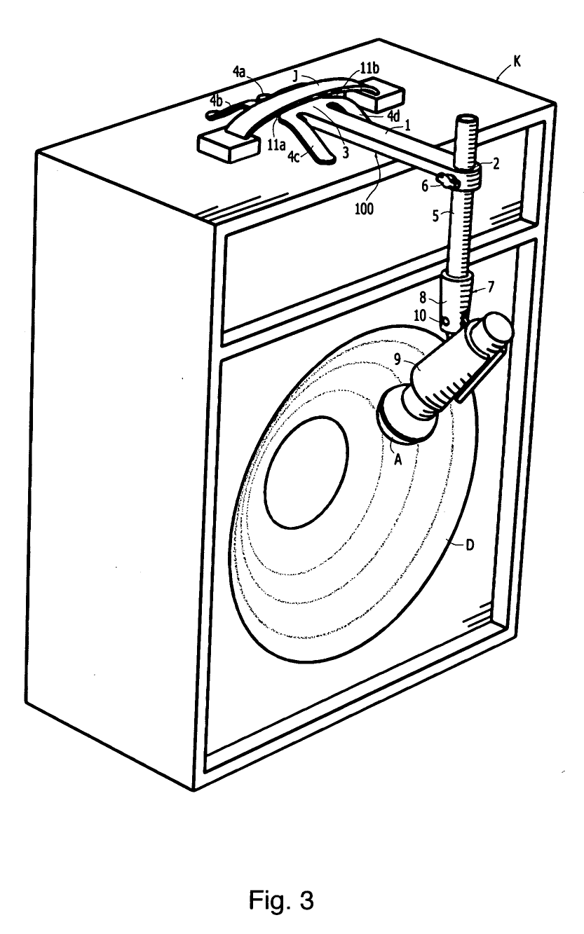

FIG. 3. shows the microphone holder assembly 100 mounted on a combo-style amplifier K. Combo-style amplifiers are devices that contain an amplifier C and a speaker cabinet B in one unit. Combo amplifiers very often have a handle J on the top. To use microphone holder assembly 100 with a combo-style amplifier K, the support member 1 is held under handle J. Support member 1 is designed with two notches 11 to capture handle J to improve positional stability.

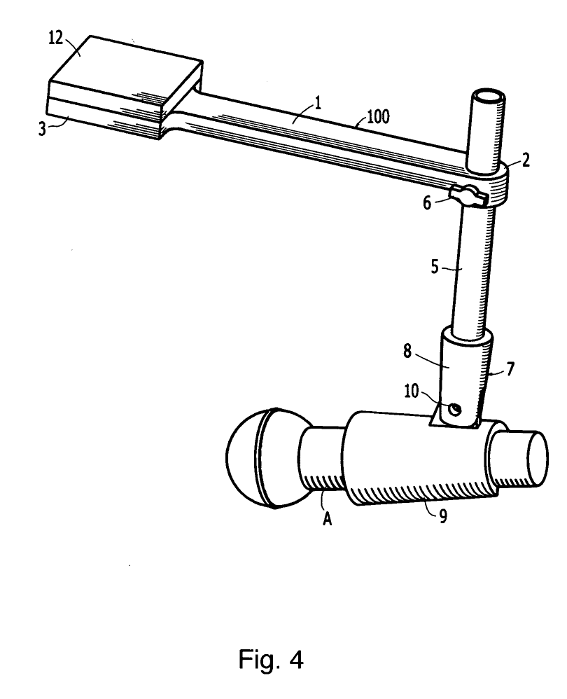

FIG. 4. shows an alternate embodiment wherein the flexible members 4 are replaced by an elastomeric pad 12. The elastomeric pad 12 can be compressed to allow support member 1 to be inserted and held in gap E.

The foregoing descriptions of the preferred embodiments of the invention have been presented for purposes of illustration and description. It is not intended to be exhaustive or to limit the invention to the precise form disclosed. Obviously many modifications and variations are possible in light of the above teachings. The embodiments were chosen and described in order to best explain the principles of the invention and its practical application to thereby enable others skilled in the art to best utilize the invention in various modifications as are suited to the particular use contemplated. It is intended that the scope of the invention be defined by the claims appended hereto.

The embodiments of the invention in which I claim an exclusive property or privilege are defined as follows:

1. A system for holding a microphone, comprising:
(a) a support member having a first end comprising one or more flexible members and a second end providing means for retaining a rod,
(b) a rod,
(c) and a microphone bracket assembly
whereby said support member fits into an opening and is held substantially rigidly by means of force provided by said flexible members due to their deflection in order to fit into said opening.

2. A system as described in claim 1 wherein said microphone bracket assembly holds a microphone for the purpose of capturing sound from a speaker.

3. A system as described in claim 1 wherein said flexible members are one or more leaf springs.

4. A system as described in claim 1 wherein said flexible member is an elastomeric pad.

5. A system as described in claim 1 wherein said opening is a gap formed between an amplifier and a speaker cabinet.

6. A system as described in claim 1 wherein said opening is the space between a handle and said handle's mounting surface.

7. A system as described in claim 6 wherein said mounting surface is part of an amplifier.

8. A system as described in claim 6 wherein said mounting surface is part of a speaker cabinet.

9. A system as described in claim 1 wherein said rod is axially adjustable.

10. A system as described in claim 1 wherein said rod is angularly adjustable.

11. A system as described in claim 1 wherein said rod is an integral feature of said support member.

12. A system as described in claim 1 wherein said rod is an integral feature of said microphone bracket assembly.

13. A system as described in claim 1 wherein said microphone bracket assembly further includes a rotating joint.

14. A method for holding a microphone, comprising:
(a) a support member having a first end comprising one or more flexible members and a second end providing means for retaining a rod,
(b) a rod,
(c) and a microphone bracket assembly
whereby said support member fits into an opening and is held substantially rigidly by means of force provided by said flexible members due to their deflection in order to fit into said opening.
